(19) United States
(12) Patent Application Publication
(10) Pub. No.: US 2024/0280686 A1
(43) Pub. Date: Aug. 22, 2024

(54) MULTI-WAVELENGTH SENSING APPARATUS AND OPERATING METHOD THEREOF

(71) Applicant: Luxar AI, Inc., Pleasanton, CA (US)

(72) Inventor: Sangsoo LEE, Cohoes, NY (US)

(21) Appl. No.: 18/443,465

(22) Filed: Feb. 16, 2024

Related U.S. Application Data
(60) Provisional application No. 63/485,608, filed on Feb. 17, 2023.

(30) Foreign Application Priority Data
Feb. 13, 2024 (KR) 10-2024-0020371

(51) Int. Cl. G01S 13/86; G01S 7/41; G01S 13/89

(52) U.S. Cl. CPC G01S 13/86; G01S 7/411; G01S 13/862; G01S 13/865; G01S 13/867; G01S 13/89

(57) ABSTRACT

Disclosed is a multi-wavelength sensing apparatus which includes a reference device that generates reference data including three-dimensional information and a reference amplitude value of an object, a first device that generates first data including first two-dimensional information and a first amplitude value of the object, a second device that generates second data including second two-dimensional information and a second amplitude value of the object, a signal mapper that maps the first data and the second data based on the reference data and generates mapping data, and at least one processor that post-processes the mapping data and obtains three-dimensional information of the object and characteristic information of the object.

### CROSS-REFERENCE TO RELATED APPLICATIONS

This application claims priority under 35 U.S.C. § 119 to Korean Patent Application No. 10-2024-0020371 filed on Feb. 13, 2024, in the Korean Intellectual Property Office, and U.S. Provisional Patent Application Ser. No. 63/485,608, filed on Feb. 17, 2023, the disclosures of which are incorporated by reference herein in their entireties.

### BACKGROUND

Embodiments of the present disclosure described herein relate to a multi-wavelength sensing apparatus and an operating method thereof, and more particularly, relate to a multi-wavelength sensing apparatus obtaining three-dimensional information about an object and characteristic information of the object and an operating method thereof.

In the next-generation mobility industry, it is necessary to obtain three-dimensional information of an object, chemical characteristic information such as a constituent substance of an object, and physical characteristic information such as a friction force of a constituent substance, for autonomous driving and safe driving. In the case of using a camera, a radar, a LiDAR, an ultrasonic sensor, etc., 3D information such as a shape and a depth of an object may be obtained, but information about a chemical characteristic and a physical characteristic of the object may not be obtained.

To obtain the chemical characteristic information and the physical characteristic information of the object, a short wavelength infrared (SWIR) technique may be used. In a short wavelength infrared band, the absorption characteristic of a substance (e.g., water and ice) to be measured varies depending on a wavelength, and thus, substances may be distinguished based on absorption characteristics.

In the case of using a plurality of ToF sensors composed of a plurality of short wavelength infrared, each component has to be identical, which increases the size and the price. Additionally, because point cloud processing is required for each ToF sensor to obtain three-dimensional information, the complexity of signal processing greatly increases.

### SUMMARY

Embodiments of the present disclosure provide a multi-wavelength sensing apparatus obtaining three-dimensional information of an object and characteristic information of the object by using a plurality of signals with different wavelengths and an operating method thereof.

According to an embodiment, a multi-wavelength sensing apparatus includes a reference device that radiates a reference signal to an object located in a pre-defined region, to receive a reference reflection signal reflected from the object, and processes the reference reflection signal to generate reference data including three-dimensional information and a reference amplitude value of the object, a first device that radiates a first signal with a first wavelength to the object, receives a first reflection signal reflected from the object, and processes the first reflection signal to generate first data including first two-dimensional information and a first amplitude value of the object, a second device that radiates a second signal with a second wavelength to the object, receives a second reflection signal reflected from the object, and processes the second reflection signal to generate second data including second two-dimensional information and a second amplitude value of the object, a signal mapper that maps the first data and the second data based on the reference data and generates mapping data, and at least one processor that post-processes the mapping data and obtains three-dimensional information of the object and characteristic information of the object.

According to an embodiment, an operation method of a multi-wavelength sensing apparatus includes radiating a reference signal, a first signal with a first wavelength, and a second signal with a second wavelength to an object located in a pre-defined region, processing a reference reflection signal reflected from the object to generate reference data including reference three-dimensional information and a reference amplitude value of the object, processing a first reflection signal reflected from the object to generate first data including first two-dimensional information and a first amplitude value of the object, processing a second reflection signal reflected from the object to generate second data including second two-dimensional information and a second amplitude value of the object, mapping the first data and the second data based on the reference data to output mapping data, and post-processing the mapping data to obtain three-dimensional information of the object and characteristic information of the object.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a multi-wavelength sensing apparatus according to an embodiment of the present disclosure.

FIG. 2 is a block diagram illustrating a reference device according to FIG. 1.

FIG. 3 is a block diagram illustrating a first device according to FIG. 1.

FIG. 4 is a graph illustrating an absorption characteristic that a short wavelength infrared signal is absorbed by moisture.

FIG. 5 is a diagram illustrating an operation of a multi-wavelength sensing apparatus according to FIG. 1.

FIG. 6 is a graph view illustrating filtered signals according to an embodiment of the present disclosure.

FIG. 7 is a graph illustrating signals which a multi-wavelength sensing apparatus according to an embodiment of the present disclosure radiates.

FIG. 8 is a diagram illustrating a process of obtaining three-dimensional information and characteristic information of an object, according to an embodiment of the present disclosure.

FIG. 9 is a block diagram illustrating a multi-wavelength sensing apparatus according to an embodiment of the present disclosure.

FIG. 10 is a block diagram illustrating a reference device according to FIG. 9.

FIG. 11 is a block diagram illustrating a first device according to FIG. 9.

FIG. 12 is a diagram illustrating an operation of a multi-wavelength sensing apparatus according to FIG. 9.

### DETAILED DESCRIPTION

Below, embodiments of the present disclosure will be described in detail and clearly to such an extent that an ordinary one in the art easily carries out the present disclosure.

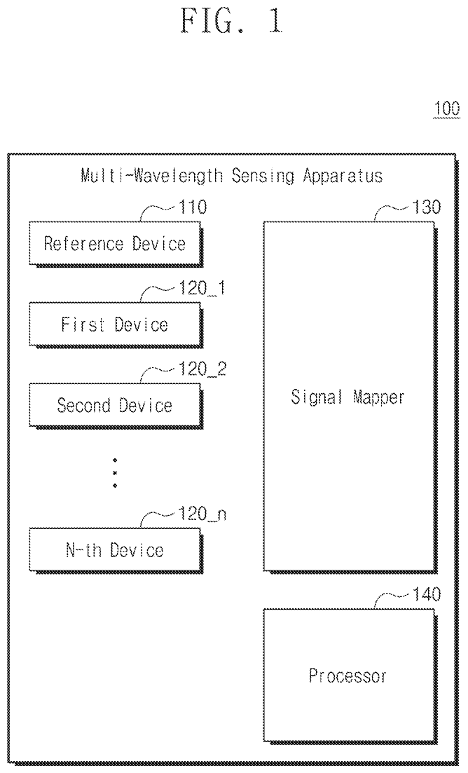

FIG. 1 is a block diagram illustrating a multi-wavelength sensing apparatus 100 according to an embodiment of the present disclosure. Referring to FIG. 1, the multi-wavelength sensing apparatus 100 may include a reference device 110, first to n-th devices 120_1 to 120_n, a signal mapper 130, and a processor 140. Herein, “n” may be a natural number more than 2.

The reference device 110 may obtain reference three-dimensional information, such as a shape of an object, a depth of an object, and a distance from an object, from an object (or substance) located in a pre-defined region. In this case, the pre-defined region which is an arbitrary region spaced apart from the multi-wavelength sensing apparatus 100 as much as a given distance may be a preset region.

For example, the reference device 110 may radiate a reference signal Sref to an object located in the pre-defined region. The reference device 110 may receive a reference reflection signal Sref_r reflected from the object located in the pre-defined region after the reference signal Sref is radiated. The reference device 110 may process the reference reflection signal Sref_r and may generate reference data Dref including reference three-dimensional information Pref and a reference amplitude value Aref which are associated with the object. The reference device 110 may provide the reference data Dref to the signal mapper 130.

The reference three-dimensional information Pref may be expressed by using three-dimensional coordinate information. For example, the reference three-dimensional information Pref may be expressed by P(xref, yref, zref). To obtain the reference three-dimensional information Pref, the reference device 110 may perform at least one of a depth calculation operation, a data calibration operation, and an error correction operation, based on coordinate information (e.g., P(x0, y0, z0)) for each pixel defined in advance.

The reference amplitude value Aref may mean an amplitude value of the reference reflection signal Sref_r, and the amplitude value of the reference reflection signal Sref_r may be different from an amplitude value of the reference signal Sref. Alternatively, the reference amplitude value Aref may mean a difference value between the amplitude value of the reference signal Sref and the amplitude value of the reference reflection signal Sref_r.

In an embodiment, the reference device 110 may be implemented with a ToF sensor.

The first to n-th devices 120_1 to 120_n may obtain two-dimensional information, such as a two-dimensional shape of an object, from an object located in the pre-defined region based on signals whose short wavelengths are independent of each other.

For example, the first device 1201 may radiate a first signal S1 with a first wavelength λ1 to the object located in the pre-defined region. The first device 120_1 may receive a first reflection signal S1_r reflected from the object located in the pre-defined region after the first signal S1 is radiated. The first device 120_1 may process the first reflection signal S1_r to generate first data D1 including first two-dimensional information P1 and a first amplitude value A1 of the object. The first device 120_1 may provide the first data D1 to the signal mapper 130.

The first two-dimensional information P1 may be expressed by using two-dimensional coordinate information. For example, the first two-dimensional information P1 of the object may be expressed by P(x1, y1).

The first amplitude value A1 may mean an amplitude value of the first reflection signal S1_r, and the amplitude value of the first reflection signal S1_r may be different from an amplitude value of the first signal S1. Alternatively, the first amplitude value A1 may mean a difference value between the amplitude value of the first signal S1 and the amplitude value of the first reflection signal S1_r.

For example, the second device 120_2 may radiate a second signal S2 with a second wavelength λ2 to the object located in the pre-defined region. The second device 1202 may receive a second reflection signal S2_r reflected from the object located in the pre-defined region after the second signal S2 is radiated. The second device 120_2 may process the second reflection signal S2_r to generate second data D2 including second two-dimensional information P2 and a second amplitude value A2 of the object. The second device 1202 may provide the second data D2 to the signal mapper 130.

The second two-dimensional information P2 of the object may be expressed by using two-dimensional coordinate information. For example, the second two-dimensional information P2 of the object may be expressed by P(x2, y2).

The second amplitude value A2 may mean an amplitude value of the second reflection signal S2_r, and the amplitude value of the second reflection signal S2_r may be different from an amplitude value of the second signal S2. Alternatively, the second amplitude value A2 may mean a difference value between the amplitude value of the second signal S2 and the amplitude value of the second reflection signal S2_r.

For example, the n-th device 120_n may radiate an n-th signal Sn with an n-th wavelength λn to the object located in the pre-defined region. The n-th device 120_n may receive an n-th reflection signal Sn_r reflected from the object located in the pre-defined region after the n-th signal Sn is radiated. The n-th device 120_n may process the n-th reflection signal Sn_r to generate n-th data Dn including n-th two-dimensional information Pn and an n-th amplitude value An of the object. The signal mapper 130 may map the data Dref to Dn received from the reference device 110 and the first to n-th devices 120_1 to 120_n. The n-th device 120_n may provide the n-th data Dn to the signal mapper 130.

The n-th two-dimensional information Pn of the object may be expressed by using two-dimensional coordinate information. For example, the n-th two-dimensional information Pn of the object may be expressed by P(xn, yn).

The n-th amplitude value An may mean an amplitude value of the n-th reflection signal Sn_r, and the amplitude value of the n-th reflection signal Sn_r may be different from an amplitude value of the n-th signal Sn. Alternatively, the n-th amplitude value An may mean a difference value between the amplitude value of the n-th signal Sn and the amplitude value of the n-th reflection signal Sn_r.

In an embodiment, at least one of the first signal S1 to the n-th signal Sn may be a short wavelength infrared signal. For example, the first signal S1 may be a near infrared (NIR) signal, and each of the second signal S2 to the n-th signal Sn may be a short wavelength infrared signal. For example, each of the first signal S1 and the second signal S2 may be a near infrared signal, and each of the third signal S3 to the n-th signal Sn may be a short wavelength infrared signal. However, the present disclosure is not limited thereto. For example, various combinations in which at least one of the first signal S1 to the n-th signal Sn becomes a short wavelength infrared signal may be possible.

The signal mapper 130 may receive the reference data Dref from the reference device 110 and may receive the first to n-th data D1 to Dn from the first to n-th devices 120_1 to 120_n. The signal mapper 130 may map the first to n-th data D1 to Dn based on the reference data Dref and may generate mapping data Dm. The signal mapper 130 may provide the mapping data Dm to the processor 140.

The processor 140 may function as a central processing unit of the multi-wavelength sensing apparatus 100. The processor 140 may control all operations of the multi-wavelength sensing apparatus 100. The processor 140 may control operations of the reference device 110, the first to n-th devices 120_1 to 120_n, and the signal mapper 130.

The processor 140 may post-process the mapping data Dm from the signal mapper 130 to obtain characteristic information of the object and three-dimensional information of the object.

For example, the processor 140 may receive the mapping data Dm from the signal mapper 130. The processor 140 may post-process the mapping data Dm to generate final data Df including the three-dimensional information and the amplitude value of the object. The processor 140 may obtain the characteristic information of the object and the three-dimensional information of the object from the final data Df. The characteristic information of the object may include chemical characteristic information such as a constituent substance of an object and physical characteristic information such as a friction force of a constituent substance.

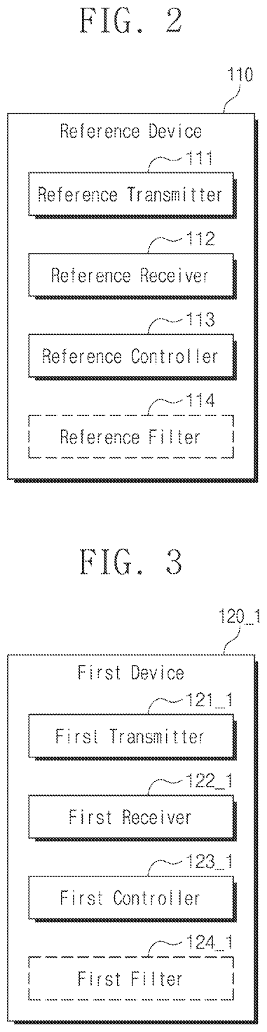

An example in which the multi-wavelength sensing apparatus 100 includes one processor 140 is illustrated in FIG. 2, but the present disclosure is not limited thereto. For example, the multi-wavelength sensing apparatus 100 may include a plurality of processors. For example, the multi-wavelength sensing apparatus 100 may include at least one general-purpose processor such as a central processing unit (CPU) or an application processor (AP) and may include at least one special-purpose processor such as a neural processing unit (NPU), a neuromorphic processor (NP), or a graphic processing unit (GPU).

FIG. 2 is a block diagram illustrating the reference device 110 according to FIG. 1. Referring to FIGS. 1 and 2, the reference device 110 may include a reference transmitter 111, a reference receiver 112, and a reference controller 113.

The reference transmitter 111 may be implemented with at least one of a radar, an ultrasonic device, a laser, and a LiDAR. The reference transmitter 111 may radiate the reference signal Sref with a reference wavelength λref to the object located in the pre-defined region. The reference signal Sref may be at least one of an optical signal, a radio signal, and an ultrasonic signal.

The reference receiver 112 may be implemented with a means for detecting at least one of an optical signal, a radio signal, and an ultrasonic signal. The reference receiver 112 may receive the reference reflection signal Sref_r reflected from the object located in the pre-defined region after the reference signal Sref is radiated.

The reference controller 113 may process a signal which the reference receiver 112 receives. For example, the reference controller 113 may process the reference reflection signal Sref_r. As a processing result, the reference controller 113 may generate the reference data Dref including the reference three-dimensional information Pref and the reference amplitude value Aref which are associated with the object located in the pre-defined region. The reference controller 113 may provide the reference data Dref to the signal mapper 130.

The reference controller 113 may perform various operations to obtain the reference three-dimensional information Pref of the object. For example, the reference controller 113 may perform at least one of a depth calculation operation, a data calibration operation, and an error correction operation.

The reference device 110 may further include a reference filter 114 which blocks (filters) a signal in any other wavelength band other than a reference radiation signal band. In this case, the reference radiation signal band may mean an arbitrary wavelength band including the reference wavelength λref of the reference signal Sref radiated by the reference transmitter 111. The reference radiation signal band may be determined by the processor 140 or the reference controller 113. The reference filter 114 may filter the reference reflection signal Sref_r received by the reference receiver 112 and may provide a filtered reference reflection signal Sref_r_f to the reference controller 113. The reference controller 113 may receive the filtered reference reflection signal Sref_r_f and may process the filtered reference reflection signal Sref_r_f.

FIG. 3 is a block diagram illustrating the first device 120_1 according to FIG. 1. Referring to FIGS. 1 and 3, the first device 1201 may include a first transmitter 121_1, a first receiver 122_1, and a first controller 123_1.

The first transmitter 121_1 may be implemented with at least one of a laser and an LED. The first transmitter 121_1 may radiate the first signal S1 with the first wavelength λ1 to the object located in the pre-defined region. The first wavelength λ1 may be a short wavelength ranging from 1 um to 2.5 um, and the first signal S1 may be an optical signal.

The first receiver 1221 may be implemented with a means for detecting an optical signal. For example, the first receiver 122_1 may be implemented with at least one of a light detector array and an image sensor. The first receiver 122_1 may receive the first reflection signal S1_r reflected from the object located in the pre-defined region after the first signal S1 is radiated.

The first controller 1231 may process a signal which the first receiver 122_1 receives. For example, the first controller 1231 may process the first reflection signal S1_r. As a processing result, the first controller 123_1 may generate the first data D1 including the first two-dimensional information P1 and the first amplitude value A1 of the object located in the pre-defined region. The first controller 123_1 may provide the first data D1 to the signal mapper 130.

The first device 1201 may further include a first filter 124_1 which blocks (filters) a signal in any other wavelength band other than a first radiation signal band. In this case, the first radiation signal band may mean a wavelength band including the first wavelength λ1 of the first signal S1 radiated by the first transmitter 121_1. The first radiation signal band may be determined by the processor 140 or the first controller 123_1. The first filter 124_1 may filter the first reflection signal S1_r received by the first receiver 122_1 and may provide a filtered first reflection signal S1_r_f to the first controller 123_1. The first controller 123_1 may receive the filtered first reflection signal S1_r_f and may process the filtered first reflection signal S1_r_f.

FIG. 3 shows the first device 120_1, but it may be understood that each of the second to n-th devices 120_2 to 120_n has the same structure as the first device 120_1. That is, the second device 120_2 may include a second transmitter, a second receiver, a second controller, and a second filter, and the n-th device 120_n may include an n-th transmitter, an n-th receiver, an n-th controller, and an n-th filter.

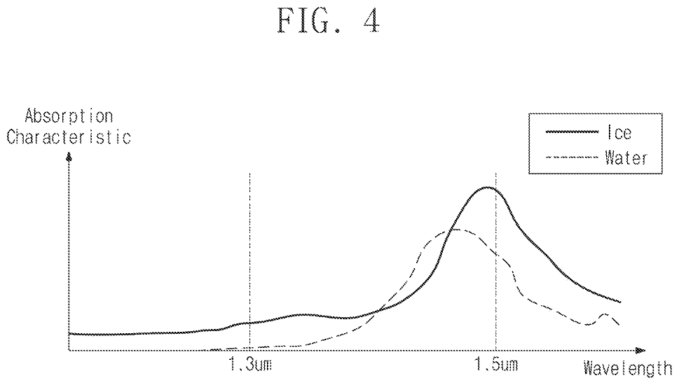

FIG. 4 is a graph illustrating an absorption characteristic that a short wavelength infrared signal is absorbed by moisture. In FIG. 4, the horizontal axis represents a wavelength, and the vertical axis represents an absorption characteristic of moisture. The absorption characteristic of moisture may be expressed in an arbitrary unit (arb.u.).

Referring to FIGS. 1 and 4, the absorption characteristic that a short wavelength infrared signal whose wavelength ranges from 1 um to 2.5 um is absorbed by moisture and, the absorption characteristic that an infrared signal of any other wavelength such as a near infrared (NIR) or a medium infrared is absorbed by moisture may be different.

In detail, when a wavelength of an optical signal is 1.3 um, the optical signal may be hardly absorbed by water but may be absorbed by ice more than by water. That is, when the wavelength of the optical signal is 1.3 um, the amount by which the optical signal is absorbed by water may be different from the amount by which the optical signal is absorbed by ice. Optical signal absorption amounts of water and ice when the wavelength of the optical signal is 1.5 um may be significantly different from those when the wavelength of the optical signal is 1.3 um.

In other words, in the short wavelength infrared band, the absorption characteristic of a substance varies depending on a wavelength. Accordingly, based on the absorption characteristic that a short wavelength infrared signal is absorbed by a substance, the multi-wavelength sensing apparatus 100 may identify a constituent substance of an object to obtain chemical characteristic information of the object (e.g., the multi-wavelength sensing apparatus 100 may distinguish water and ice on a road). Also, the multi-wavelength sensing apparatus 100 may obtain physical characteristic information, such as a friction force.

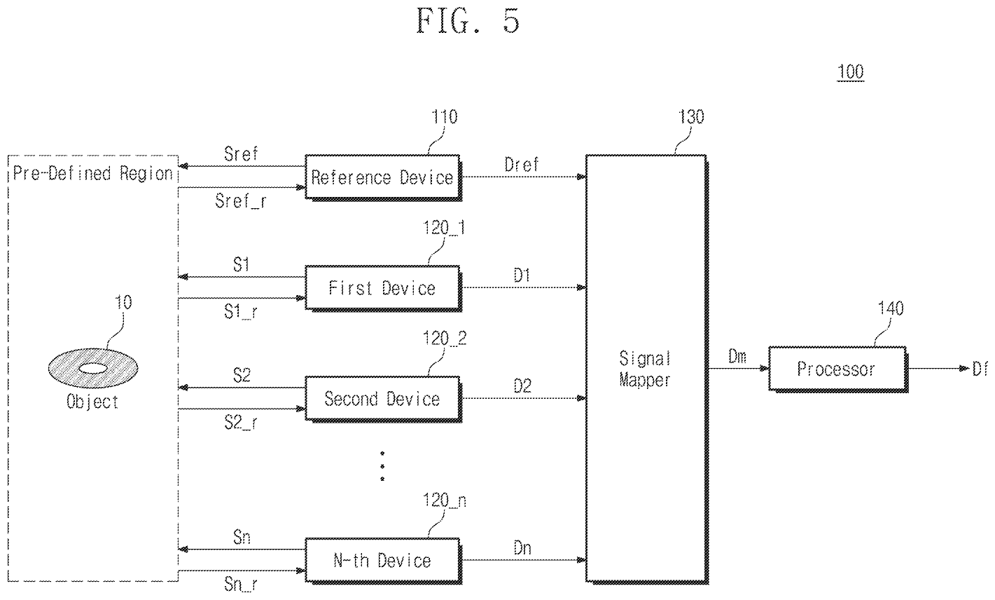

FIG. 5 is a diagram illustrating an operation of the multi-wavelength sensing apparatus 100 according to FIG. 1. Referring to FIGS. 1 to 3 and 5, the multi-wavelength sensing apparatus 100 may obtain three-dimensional information and characteristic information of an object 10 located in the pre-defined region.

The reference device 110 may obtain the reference three-dimensional information Pref of the object 10 from the object 10 located in the pre-defined region.

For example, the reference device 110 may radiate the reference signal Sref with the reference wavelength λref to the object 10 located in the pre-defined region. The reference signal Sref may be at least one of an optical signal, a radio signal, and an ultrasonic signal. The reference device 110 may receive the reference reflection signal Sref_r reflected from the object 10 located in the pre-defined region after the reference signal Sref is radiated. The reference device 110 may process the reference reflection signal Sref_r and may generate the reference data Dref including the reference three-dimensional information Pref and the reference amplitude value Aref of the object 10. The reference device 110 may provide the reference data Dref to the signal mapper 130.

The first to n-th devices 120_1 to 120_n may obtain the first to n-th two-dimensional information P1 to Pn of the object 10 from the object 10 located in the pre-defined region by using signals whose short wavelengths are independent of each other.

For example, the first device 120_1 may radiate the first signal S1 with the first wavelength λ1 to the object 10 located in the pre-defined region. The first wavelength λ1 may be a short wavelength ranging from 1 um to 2.5 um, and the first signal S1 may be an optical signal. The first device 1201 may receive the first reflection signal S1_r reflected from the object 10 after the first signal S1 is radiated. The first device 120_1 may process the first reflection signal S1_r to generate the first data D1 including the first two-dimensional information P1 and the first amplitude value A1 of the object 10. The first device 1201 may provide the first data D1 to the signal mapper 130.

For example, the second device 120_2 may radiate the second signal S2 with the second wavelength λ2 to the object 10 located in the pre-defined region. The second wavelength λ2 may be a short wavelength which ranges from 1 um to 2.5 um and is different from that of the first wavelength λ1, and the second signal S2 may be an optical signal. The second device 120_2 may receive the second reflection signal S2_r reflected from the object 10 after the second signal S2 is radiated. The second device 120_2 may process the second reflection signal S2_r to generate the second data D2 including the second two-dimensional information P2 and the second amplitude value A2 of the object 10. The second two-dimensional information P2 may be different from the first two-dimensional information P1, and the second amplitude value A2 may be different from the first amplitude value A1. The second device 120_2 may provide the second data D2 to the signal mapper 130.

For example, the n-th device 120_n may radiate the n-th signal Sn with the n-th wavelength λn to the object 10 located in the pre-defined region. The n-th wavelength λn may be a short wavelength which ranges from 1 um to 2.5 um and is independent of those of the first to (n−1)-th wavelengths λ2 to λ(n−1), and the n-th signal Sn may be an optical signal. The n-th device 120_n may receive the n-th reflection signal Sn_r reflected from the object 10 after the n-th signal Sn is radiated. The n-th device 120_n may process the n-th reflection signal Sn_r to generate the n-th data Dn including the n-th two-dimensional information Pn and the n-th amplitude value An of the object 10. The n-th two-dimensional information Pn may be different from the first to (n−1)-th two-dimensional information P1 to P(n−1), and the n-th amplitude value An may be different from the first to (n−1)-th amplitude values A1 to A(n−1). The n-th device 120_n may provide the n-th data Dn to the signal mapper 130.

The signal mapper 130 may map the data Dref to Dn received from the reference device 110 and the first to n-th devices 120_1 to 120_n.

For example, the signal mapper 130 may receive the reference data Dref from the reference device 110 and may receive the first to n-th data D1 to Dn from the first to n-th devices 120_1 to 120_n. The signal mapper 130 may map the first to n-th data D1 to Dn based on the reference data Dref and may generate the mapping data Dm. The signal mapper 130 may provide the mapping data Dm to the processor 140.

The processor 140 may post-process the mapping data Dm from the signal mapper 130 to obtain characteristic information of the object 10 and three-dimensional information of the object 10.

For example, the processor 140 may receive the mapping data Dm from the signal mapper 130. The processor 140 may post-process the mapping data Dm to generate the final data Df including the three-dimensional information and the amplitude value of the object 10. The processor 140 may obtain the characteristic information of the object 10 and the three-dimensional information of the object 10 from the final data Df. The characteristic information of the object 10 may include chemical characteristic information such as a constituent substance of an object and physical characteristic information such as a friction force of a constituent substance.

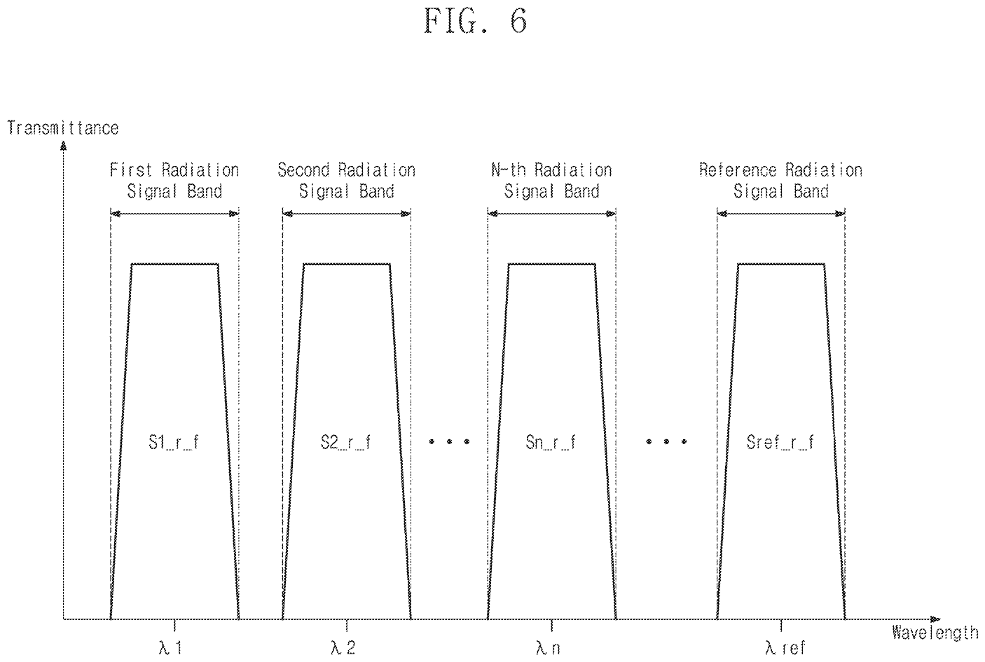

FIG. 6 is a graph illustrating filtered signals S1_r_f to Sn_r_f and Sref_r_f according to an embodiment of the present disclosure. In FIG. 6, the horizontal axis represents a wavelength, and the vertical axis represents transmittance. In FIG. 6, the first to n-th wavelengths λ1 to an may be independent wavelengths within a wavelength range from 1 um to 2.5 um.

Referring to FIGS. 1 and 6, the reference filter 114 may filter the reference reflection signal Sref_r, and first to n-th filters 124_1 to 124_n may filter the first to n-th reflection signals S1_r to Sn_r.

For example, the reference filter 114 of the reference device 110 may filter the reference reflection signal Sref_r. The filtered reference reflection signal Sref_r_f may be a signal which is obtained by filtering the reference reflection signal Sref_r such that any other wavelength band other than the reference radiation signal band is blocked. The reference radiation signal band may mean an arbitrary wavelength band including the reference wavelength λref of the reference signal Sref radiated by the reference transmitter 111.

For example, the first filter 124_1 of the first device 120_1 may filter the first reflection signal S1_r. The filtered first reflection signal S1_r_f may be a signal which is obtained by filtering the first reflection signal S1_r such that any other wavelength band other than the first radiation signal band is blocked. The first radiation signal band may mean a wavelength band including the first wavelength λ1 of the first signal S1 radiated by the first transmitter 121_1.

For example, the second filter 124_2 of the second device 1202 may filter the second reflection signal S2_r. The filtered second reflection signal S2_r_f may be a signal which is obtained by filtering the second reflection signal S2_r such that any other wavelength band other than the second radiation signal band is blocked. The second radiation signal band may mean a wavelength band including the second wavelength λ2 of the second signal S2 radiated by a second transmitter.

For example, the n-th filter 124_n of the n-th device 120_n may filter the n-th reflection signal Sn_r. The filtered n-th reflection signal Sref_r_f may be a signal which is obtained by filtering the n-th reflection signal Sn_r such that any other wavelength band other than the n-th radiation signal band is blocked. The n-th radiation signal band may mean an arbitrary wavelength band including the n-th wavelength an of the n-th signal Sn by an n-th transmitter.

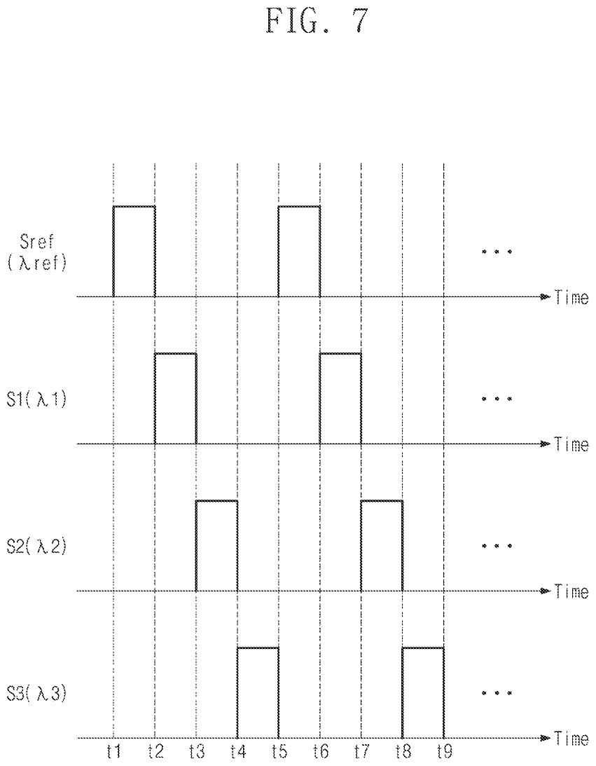

FIG. 7 is a graph illustrating signals which a multi-wavelength sensing apparatus according to an embodiment of the present disclosure radiates. In FIG. 7, the horizontal axis represents a time. In FIG. 7, it is assumed that the multi-wavelength sensing apparatus 100 of FIG. 1 includes the first to third devices 120_1 to 1203 (i.e., n=3).

Referring to FIGS. 1 to 3, 5, and 7, the reference device 110 and the first to third devices 120_1 to 120_3 of the multi-wavelength sensing apparatus 100 may operate as points in time t1 to t7 progress. The multi-wavelength sensing apparatus 100 may radiate pulse-shaped signals Sref, S1, S2, and S3 whose wavelengths are independent of each other, in a time division multiplexing manner.

For example, the reference device 110 of the multi-wavelength sensing apparatus 100 may radiate the reference signal Sref with the reference wavelength λref during a time period from t1 to t2 and a time period t5 to t6. The first device 120_1 of the multi-wavelength sensing apparatus 100 may radiate the first signal S1 with the first wavelength λ1 during a time period from t2 to t3 and a time period t6 to t7. The second device 120_2 of the multi-wavelength sensing apparatus 100 may radiate the second signal S2 with the second wavelength λ2 during a time period from t3 to t4 and a time period t7 to t8. The third device 120_3 of the multi-wavelength sensing apparatus 100 may radiate the third signal S3 with the third wavelength λ3 during a time period from t4 to t5 and a time period t8 to t9.

In some embodiments, the reference signal Sref may be at least one of an optical signal, a radio signal, and an ultrasonic signal.

In an embodiment, at least one of the first signal S1 to the third signal S3 may be a short wavelength infrared signal. For example, the first signal S1 may be a near infrared signal, and each of the second signal S2 and the third signal S3 may be a short wavelength infrared signal. However, the present disclosure is not limited thereto. For example, various combinations in which at least one of the first signal S1 to the third signal S3 becomes a short wavelength infrared signal may be possible.

As described above, the multi-wavelength sensing apparatus 100 may radiate pulse-shaped signals having independent wavelengths in the time division multiplexing manner. That is, the multi-wavelength sensing apparatus 100 may distribute pulse-shaped signals so as to be radiated in different time bands, and thus, the crosstalk between a signal and a background noise may be reduced.

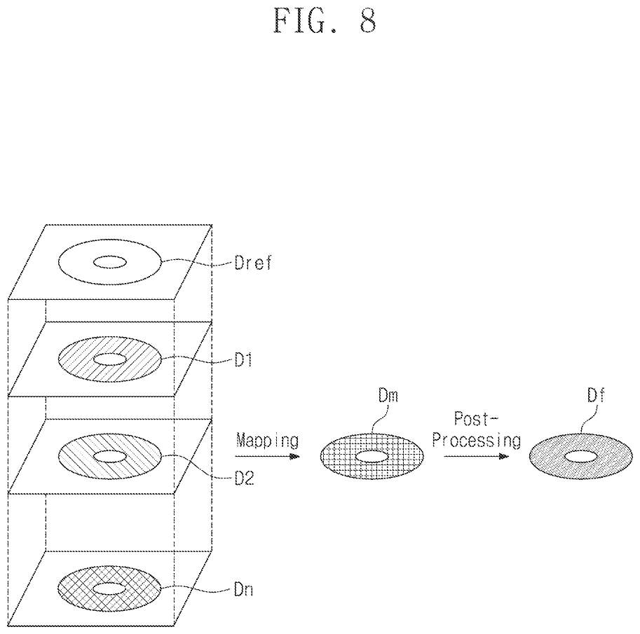

FIG. 8 is a diagram illustrating a process of obtaining three-dimensional information and characteristic information of an object, according to an embodiment of the present disclosure. Referring to FIGS. 1, 5, and 8, the signal mapper 130 may generate the mapping data Dm by mapping the first to n-th data D1 to Dn based on the reference data Dref.

For example, the signal mapper 130 may map x-axis and y-axis coordinates of each of the first two-dimensional information P1 to the n-th two-dimensional information Pn based on x-axis and y-axis coordinates of the reference three-dimensional information Pref. As a mapping result, the signal mapper 130 may generate the mapping data Dm and may provide the mapping data Dm to the processor 140.

The processor 140 may post-process the mapping data Dm from the signal mapper 130 to obtain characteristic information of the object and three-dimensional information of the object.

For example, the processor 140 may post-process the mapping data Dm to generate the final data Df including the three-dimensional information and the amplitude value of the object. The processor 140 may obtain the characteristic information of the object from the amplitude value of the final data Df, based on an absorption characteristic of a substance, that is, a characteristic that a short wavelength infrared is absorbed by the substance.

The three-dimensional information of the object and the characteristic information of the object, which are described above, may be determined based on Equation 1 below.

$$Df ( P , A ) = a 0 * Dref ( Pref , Aref ) + {\sum }_{k = 1}^{m} ak * Dk ( Pk , Ak ) \qquad [ Equation 1 ]$$

In Equation 1 above, “m” is a natural number more than or equal to 2, “Df(P, A)” represents final data, “P” represents three-dimensional information about an object, “A” represents an amplitude value of the final data Df, “Dref(Pref, Aref)” represents reference data generated by the reference device 110, “Pref” represents reference three-dimensional information obtained by the reference device 110, “Aref” represents a reference amplitude value obtained by the reference device 110, “Dk(Pk, Ak)” represents k-th data obtained by a k-th device, “Pk” represents k-th two-dimensional information obtained by the k-th device, “Ak” represents a k-th amplitude value obtained by the k-th device, and each of a0 to ak represents a post-processing coefficient.

For example, when “m” is 2, the three-dimensional information “P” of the final data Df is expressed by three-dimensional coordinates, P(x, y, z), the reference three-dimensional information Pref is expressed by three-dimensional coordinates, P(xref, yref, zref), the first two-dimensional information P1 is expressed by two-dimensional coordinates, P(x1, y1), and the second two-dimensional information P2 is expressed as two-dimensional coordinates, P(x2, y2), the three-dimensional information “P” of the final data Df, that is, P(x, y, z) is determined as “a0*P(xref, yref, zref)+a1*P1(x1, x2)+a2*P2(x2, y2)”, and the amplitude value “A” of the final data Df is determined as “a0*Aref+a1*A1+a2*A2”. In this case, the processor 140 may obtain the characteristic information of the object from the amplitude value “A” of the final data Df.

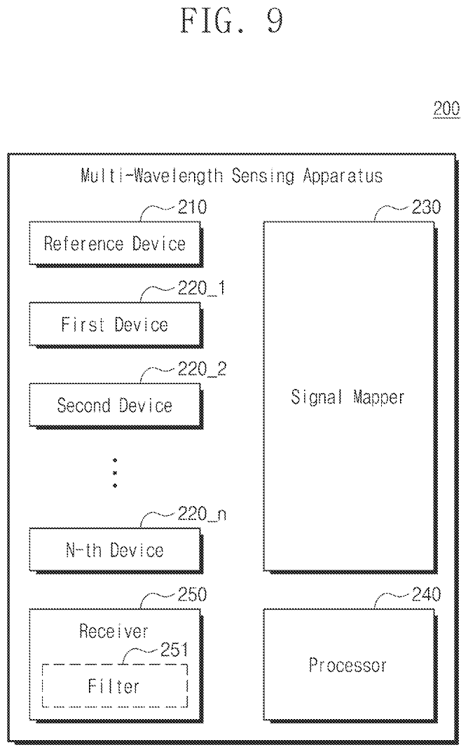

FIG. 9 is a block diagram illustrating a multi-wavelength sensing apparatus 200 according to an embodiment of the present disclosure. A configuration of the multi-wavelength sensing apparatus 200 of FIG. 9 is the same as the configuration of the multi-wavelength sensing apparatus 100 of FIG. 1 except for some components. Thus, additional description will be omitted to avoid redundancy.

Referring to FIG. 9, the multi-wavelength sensing apparatus 200 may include a reference device 210, first to n-th devices 220_1 to 220_n, a signal mapper 230, a processor 240, and a receiver 250. Herein, “n” may be a natural number more than 2.

The reference device 210 may radiate the reference signal Sref to an object located in the pre-defined region. The reference device 210 may receive the reference reflection signal Sref_r from the receiver 250. The reference device 210 may process the reference reflection signal Sref_r and may generate the reference data Dref including the reference three-dimensional information Pref and the reference amplitude value Aref which are associated with the object. The reference device 210 may provide the reference data Dref to the signal mapper 230.

The first device 2201 may radiate the first signal S1 with the first wavelength λ1 to the object located in the pre-defined region. The first device 2201 may receive the first reflection signal S1_r from the receiver 250. The first device 2201 may process the first reflection signal S1_r to generate the first data D1 including the first two-dimensional information P1 and the first amplitude value A1 of the object. The first device 220_1 may provide the first data D1 to the signal mapper 230.

The second device 2202 may radiate the second signal S2 with the second wavelength λ2 to the object located in the pre-defined region. The second device 220_2 may receive the second reflection signal S2_r from the receiver 250. The second device 220_2 may process the second reflection signal S2_r_f to generate the second data D2 including the second two-dimensional information P2 and the second amplitude value A2 of the object. The second device 220_2 may provide the second data D2 to the signal mapper 230.

The n-th device 220_n may radiate the n-th signal Sn with the n-th wavelength λn to the object located in the pre-defined region. The n-th device 220_n may receive the n-th reflection signal Sn_r from the receiver 250. The n-th device 220_n may process the n-th reflection signal Sn_r to generate the n-th data Dn including the n-th two-dimensional information Pn and the n-th amplitude value An of the object. The n-th device 220_n may provide the n-th data Dn to the signal mapper 230.

In an embodiment, at least one of the first signal S1 to the n-th signal Sn may be a short wavelength infrared signal. For example, the first signal S1 may be a near infrared signal, and each of the second signal S2 to the n-th signal Sn may be a short wavelength infrared signal. For example, each of the first signal S1 and the second signal S2 may be a near infrared signal, and each of the third signal S3 to the n-th signal Sn may be a short wavelength infrared signal. However, the present disclosure is not limited thereto. For example, various combinations in which at least one of the first signal S1 to the n-th signal Sn becomes a short wavelength infrared signal may be possible.

The signal mapper 230 may receive the reference data Dref from the reference device 210 and may receive the first to n-th data D1 to Dn from the first to n-th devices 220_1 to 220_n. The signal mapper 230 may map the first to n-th data D1 to Dn based on the reference data Dref and may generate the mapping data Dm. The signal mapper 230 may provide the mapping data Dm to the processor 240.

The processor 240 may post-process the mapping data Dm from the signal mapper 230 to obtain characteristic information of the object and three-dimensional information of the object.

For example, the processor 240 may receive the mapping data Dm from the signal mapper 230. The processor 240 may post-process the mapping data Dm to generate the final data Df including the three-dimensional information and the amplitude value of the object. The processor 240 may obtain the characteristic information of the object and the three-dimensional information of the object from the final data Df. The characteristic information of the object may include chemical characteristic information such as a constituent substance of an object and physical characteristic information such as a friction force of a constituent substance.

The receiver 250 may receive signals reflected from the object located in the pre-defined region. The receiver 250 may provide the received signals to the reference device 210 and the first to n-th devices 220_1 to 220_n, respectively.

For example, the receiver 250 may receive the reference reflection signal Sref_r reflected from the object located in the pre-defined region after the reference signal Sref is radiated. The receiver 250 may provide the reference reflection signal Sref_r to the reference device 210.

For example, the receiver 250 may receive the first reflection signal S1_r reflected from the object located in the pre-defined region after the first signal S1 is radiated. The receiver 250 may provide the first reflection signal S1_r to the first device 220_1.

For example, the receiver 250 may receive a second reflection signal S2_r reflected from the object located in the pre-defined region after the second signal S2 is radiated. The receiver 250 may provide the second reflection signal S2_r to the second device 220_2.

For example, the receiver 250 may receive the n-th reflection signal Sn_r reflected from the object located in the pre-defined region after the n-th signal Sn is radiated. The receiver 250 may provide the n-th reflection signal Sn_r to the n-th device 220_n.

The receiver 250 may include a filter 251 which blocks a signal of any other wavelength band other than the radiation signal bands of the first to n-th devices 220_1 to 220_n. The filter 251 may filter the signals reflected from the object located in the pre-defined region. The filter 251 may provide the filtered signals to the reference device 210 and the first to n-th devices 220_1 to 220_n, respectively.

For example, the filter 251 may filter the reference reflection signal Sref_r which the receiver 250 receives. The filtered reference reflection signal Sref_r_f may be a signal which is obtained by filtering the reference reflection signal Sref_r such that any other wavelength band other than the reference radiation signal band is blocked. The filter 251 may provide the filtered reference reflection signal Sref_r_f to the reference device 210. The reference device 210 may receive the filtered reference reflection signal Sref_r_f and may process the filtered reference reflection signal Sref_r_f.

For example, the filter 251 may filter the first reflection signal S1_r which the receiver 250 receives. The filtered first reflection signal S1_r_f may be a signal which is obtained by filtering the first reflection signal S1_r such that any other wavelength band other than the first radiation signal band is blocked. The filter 251 may provide the filtered first reflection signal S1_r_f to the first device 220_1. The first device 2201 may receive the filtered first reflection signal S1_r_f and may process the filtered first reflection signal S1_r_f.

For example, the filter 251 may filter the second reflection signal S2_r which the receiver 250 receives. The filtered second reflection signal S2_r_f may be a signal which is obtained by filtering the second reflection signal S2_r such that any other wavelength band other than the second radiation signal band is blocked. The filter 251 may provide the filtered second reflection signal S2_r_f to the second device 220_2. The second device 2202 may receive the filtered second reflection signal S2_r_f and may process the filtered second reflection signal S2_r_f.

For example, the filter 251 may filter the n-th reflection signal Sn_r which the receiver 250 receives. The filtered n-th reflection signal Sn_r_f may be a signal which is obtained by filtering the n-th reflection signal Sn_r such that any other wavelength band other than the n-th radiation signal band is blocked. The filter 251 may provide the filtered n-th reflection signal Sn_r_f to the n-th device 220_n. The n-th device 220_n may receive the filtered n-th reflection signal Sn_r_f and may process the filtered n-th reflection signal Sn_r_f.

In an embodiment, the filter 251 may be implemented with a band pass filter.

FIG. 10 is a block diagram illustrating the reference device 210 according to FIG. 9. Referring to FIGS. 9 and 10, the reference device 210 may include a reference transmitter 211 and a reference controller 212.

The reference transmitter 211 may be implemented with at least one of a radar, an ultrasonic device, a laser, and a LiDAR. The reference transmitter 211 may radiate the reference signal Sref with the reference wavelength λref to the object located in the pre-defined region. The reference signal Sref may be at least one of an optical signal, a radio signal, and an ultrasonic signal.

The reference controller 212 may process a signal which the receiver 250 receives. For example, the reference controller 212 may process the reference reflection signal Sref_r. As a processing result, the reference controller 212 may generate the reference data Dref including the reference three-dimensional information Pref and the reference amplitude value Aref which are associated with the object located in the pre-defined region. The reference controller 212 may provide the reference data Dref to the signal mapper 230.

For example, the reference controller 212 may process the filtered reference reflection signal Sref_r_f. As a processing result, the reference controller 212 may generate the reference data Dref including the reference three-dimensional information Pref and the reference amplitude value Aref which are associated with the object located in the pre-defined region. The reference controller 212 may provide the reference data Dref to the signal mapper 230.

The reference controller 212 may perform various operations to obtain the reference three-dimensional information Pref of the object. For example, the reference controller 212 may perform at least one of a depth calculation operation, a data calibration operation, and an error correction operation.

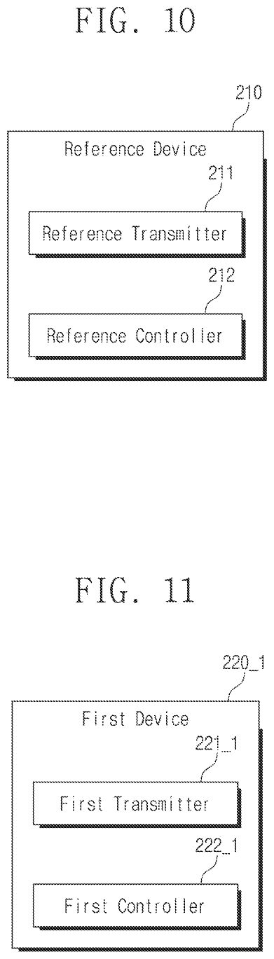

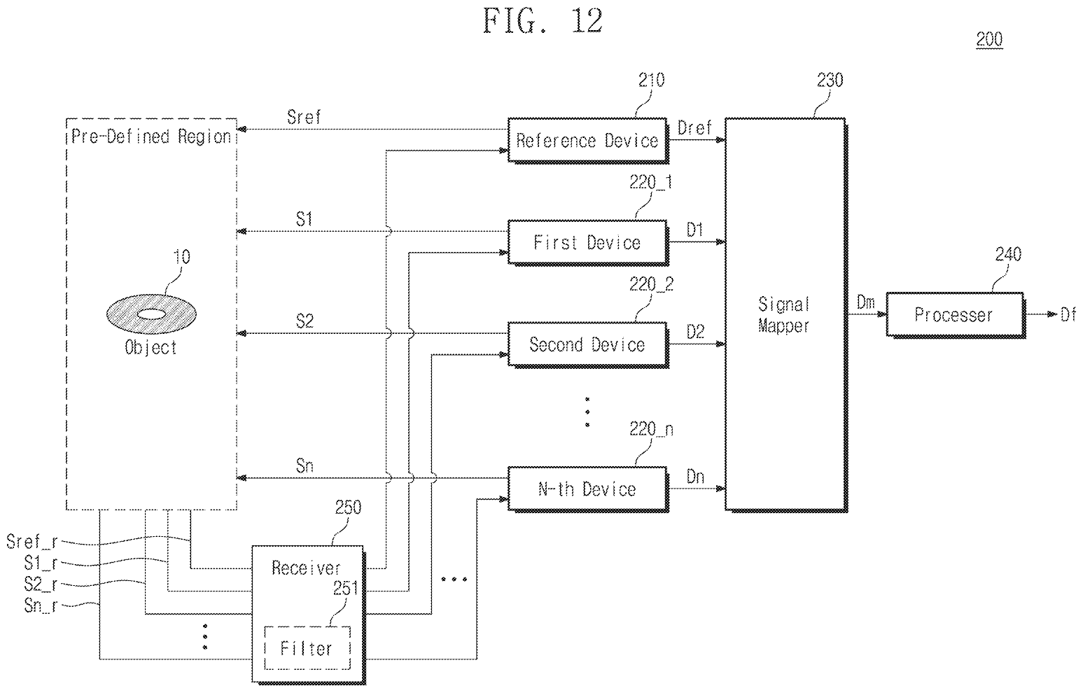

FIG. 11 is a block diagram illustrating the first device 220_1 according to FIG. 9. Referring to FIGS. 9 and 11, the first device 220_1 may include a first transmitter 221_1 and a first controller 222_1.

The first transmitter 221_1 may be implemented with at least one of a laser and an LED. The first transmitter 221_1 may radiate the first signal S1 with the first wavelength λ1 to the object located in the pre-defined region. The first wavelength λ1 may be a short wavelength ranging from 1 um to 2.5 um, and the first signal S1 may be an optical signal.

The first controller 222_1 may process a signal which the receiver 250 receives. For example, the first controller 222_1 may process the first reflection signal S1_r. As a processing result, the first controller 222_1 may generate the first data D1 including the first two-dimensional information P1 and the first amplitude value A1 of the object located in the pre-defined region. The first controller 222_1 may provide the first data D1 to the signal mapper 230.

For example, the first controller 222_1 may process the filtered first reflection signal S1_r_f. As a processing result, the first controller 222_1 may generate the first data D1 including the first two-dimensional information P1 and the first amplitude value A1 of the object located in the pre-defined region. The first controller 222_1 may provide the first data D1 to the signal mapper 230.

FIG. 11 shows the first device 220_1, but it may be understood that each of the second to n-th devices 220_2 to 220_n has the same structure as the first device 220_1. That is, the second device 220_2 may include a second transmitter and a second controller, and the n-th device 220_n may include an n-th transmitter and an n-th controller.

FIG. 12 is a diagram illustrating an operation of the multi-wavelength sensing apparatus 200 according to FIG. 9. Referring to FIGS. 9 to 12, the multi-wavelength sensing apparatus 200 may obtain three-dimensional information and characteristic information of the object 10 located in the pre-defined region.

The reference device 210 may radiate the reference signal Sref to the object 10 located in the pre-defined region and may generate the reference data Dref by processing a signal received from the receiver 250. In this case, the reference signal Sref may be at least one of an optical signal, a radio signal, and an ultrasonic signal.

For example, the reference device 210 may radiate the reference signal Sref with the reference wavelength λref to the object 10 located in the pre-defined region. The receiver 250 may receive the reference reflection signal Sref_r reflected from the object 10 and may provide the reference reflection signal Sref_r to the reference device 210. The reference device 210 may process the reference reflection signal Sref_r and may generate the reference data Dref including the reference three-dimensional information Pref and the reference amplitude value Aref of the object 10. The reference device 210 may provide the reference data Dref to the signal mapper 230.

For example, the reference device 210 may radiate the reference signal Sref with the reference wavelength λref to the object 10 located in the pre-defined region. The receiver 250 may receive the reference reflection signal Sref_r reflected from the object 10 and may filter the reference reflection signal Sref_r. The receiver 250 may provide the filtered reference reflection signal Sref_r_f to the reference device 210. The reference device 210 may process the filtered reference reflection signal Sref_r_f and may generate the reference data Dref including the reference three-dimensional information Pref and the reference amplitude value Aref of the object 10. The reference device 210 may provide the reference data Dref to the signal mapper 230.

The first device 2201 may radiate the first signal S1 with the first wavelength λ1 to the object 10 located in the pre-defined region and may generate the first data D1 by processing a signal received from the receiver 250. In this case, the first wavelength λ1 may be a short wavelength ranging from 1 um to 2.5 um, and the first signal S1 may be an optical signal.

For example, the first device 220_1 may radiate the first signal S1 to the object 10 located in the pre-defined region. The receiver 250 may receive the first reflection signal S1_r reflected from the object 10 and may provide the first reflection signal S1_r to the first device 220_1. The first device 220_1 may process the first reflection signal S1_r to generate the first data D1 including the first two-dimensional information P1 and the first amplitude value A1 of the object 10. The first device 220_1 may provide the first data D1 to the signal mapper 230.

For example, the first device 220_1 may radiate the first signal S1 to the object 10 located in the pre-defined region. The receiver 250 may receive the first reflection signal S1_r reflected from the object 10 and may filter the first reflection signal S1_r. The receiver 250 may provide the filtered first reflection signal S1_r_f to the first device 220_1. The first device 220_1 may process the filtered first reflection signal S1_r_f to generate the first data D1 including the first two-dimensional information P1 and the first amplitude value A1 of the object 10. The first device 220_1 may provide the first data D1 to the signal mapper 230.

The second device 2202 may radiate the second signal S2 with the second wavelength λ2 to the object 10 located in the pre-defined region and may generate the second data D2 by processing a signal received from the receiver 250. In this case, the second wavelength λ2 may be a short wavelength which ranges from 1 um to 2.5 um and is different from that of the first wavelength λ1, and the second signal S2 may be an optical signal S2.

For example, the second device 220_2 may radiate the second signal S2 to the object 10 located in the pre-defined region. The receiver 250 may receive the second reflection signal S2_r reflected from the object 10 and may provide the second reflection signal S2_r to the second device 220_2. The second device 220_2 may process the second reflection signal S2_r to generate the second data D2 including the second two-dimensional information P2 and the second amplitude value A2 of the object 10. The second device 2202 may provide the second data D2 to the signal mapper 230.

For example, the second device 220_2 may radiate the second signal S2 to the object 10 located in the pre-defined region. The receiver 250 may receive the second reflection signal S2_r reflected from the object 10 and may filter the second reflection signal S2_r. The receiver 250 may provide the filtered second reflection signal S2_r_f to the second device 220_2. The second device 220_2 may process the filtered second reflection signal S2_r_f to generate the second data D2 including the second two-dimensional information P2 and the second amplitude value A2 of the object 10. The second device 2202 may provide the second data D2 to the signal mapper 230.

The n-th device 220_n may radiate the n-th signal Sn with the n-th wavelength λn to the object 10 located in the pre-defined region and may generate the n-th data Dn by processing a signal received from the receiver 250. In this case, the n-th wavelength λn may be a short wavelength which ranges from 1 um to 2.5 um and is different of those of the first to (n−1)-th wavelengths λ1 to λ(n−1), and the n-th signal Sn may be an optical signal.

For example, the n-th device 220_n may radiate the n-th signal Sn to the object 10 located in the pre-defined region. The receiver 250 may receive the n-th reflection signal Sn_r reflected from the object 10 and may provide the n-th reflection signal Sn_r to the n-th device 220_n. The n-th device 220_n may process the n-th reflection signal Sn_r to generate the n-th data Dn including the n-th two-dimensional information Pn and the n-th amplitude value An of the object 10. The n-th device 220_n may provide the n-th data Dn to the signal mapper 230.

For example, the n-th device 220_n may radiate the n-th signal Sn to the object 10 located in the pre-defined region. The receiver 250 may receive the n-th reflection signal Sn_r reflected from the object 10 and may filter the n-th reflection signal Sn_r. The receiver 250 may provide the filtered n-th reflection signal Sn_r_f to the n-th device 220_n. The n-th device 220_n may process the filtered n-th reflection signal Sn_r_f to generate the n-th data Dn including the n-th two-dimensional information Pn and the n-th amplitude value An of the object 10. The n-th device 220_n may provide the n-th data Dn to the signal mapper 230.

The signal mapper 230 may map the data Dref to Dn received from the reference device 210 and the first to n-th devices 220_1 to 220_n.

For example, the signal mapper 230 may receive the reference data Dref from the reference device 210 and may receive the first to n-th data D1 to Dn from the first to n-th devices 220_1 to 220_n. The signal mapper 230 may map the first to n-th data D1 to Dn based on the reference data Dref and may generate the mapping data Dm. The signal mapper 230 may provide the mapping data Dm to the processor 240.

The processor 240 may post-process the mapping data Dm from the signal mapper 230 to obtain characteristic information of the object 10 and three-dimensional information of the object 10.

For example, the processor 240 may receive the mapping data Dm from the signal mapper 230. The processor 240 may post-process the mapping data Dm to generate the final data Df including the three-dimensional information and the amplitude value of the object 10. The processor 240 may obtain the characteristic information of the object 10 and the three-dimensional information of the object 10 from the final data Df. The characteristic information of the object 10 may include chemical characteristic information such as a constituent substance of an object and physical characteristic information such as a friction force of a constituent substance.

In the above embodiments, components according to embodiments of the present disclosure are illustrated by using blocks. The blocks may be implemented with various hardware devices, such as an integrated circuit, an application specific IC (ASIC), a field programmable gate array (FPGA), and a complex programmable logic device (CPLD), firmware driven in hardware devices, software such as an application, or a combination of a hardware device and software. Also, the blocks may include circuits implemented with semiconductor elements in an integrated circuit, or circuits enrolled as an intellectual property (IP).

According to the present disclosure, a multi-wavelength sensing apparatus may be divided into a three-dimensional information measurement unit and a two-dimensional information measurement unit. The two-dimensional information measurement unit may simplify signal processing by using a plurality of short wavelength infrared signals.

According to the present disclosure, the multi-wavelength sensing apparatus may simultaneously measure both three-dimensional information of an object and characteristic information of a constituent substance of the object by simplifying a configuration.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A multi-wavelength sensing apparatus comprising:
a reference device configured to radiate a reference signal to an object located in a pre-defined region, to receive a reference reflection signal reflected from the object, and to process the reference reflection signal to generate reference data including three-dimensional information and a reference amplitude value of the object;
a first device configured to radiate a first signal with a first wavelength to the object, to receive a first reflection signal reflected from the object, and to process the first reflection signal to generate first data including first two-dimensional information and a first amplitude value of the object;
a second device configured to radiate a second signal with a second wavelength to the object, to receive a second reflection signal reflected from the object, and to process the second reflection signal to generate second data including second two-dimensional information and a second amplitude value of the object;
a signal mapper configured to map the first data and the second data based on the reference data and to generate mapping data; and
at least one processor configured to post-process the mapping data and to obtain three-dimensional information of the object and characteristic information of the object.

2. The multi-wavelength sensing apparatus of claim 1, wherein the first wavelength and the second wavelength are independent of each other, and
wherein at least one of the first signal and the second signal is a short wavelength infrared signal.

3. The multi-wavelength sensing apparatus of claim 2, wherein the characteristic information includes physical characteristic information and chemical characteristic information of the object.

4. The multi-wavelength sensing apparatus of claim 3, wherein the characteristic information is obtained based on an absorption characteristic that the first signal is absorbed by a substance and an absorption characteristic that the second signal is absorbed by the substance.

5. The multi-wavelength sensing apparatus of claim 1, wherein the reference device performs at least one of a depth calculation operation, a data calibration operation, and an error correction operation to obtain the reference three-dimensional information.

6. The multi-wavelength sensing apparatus of claim 1, wherein the reference signal, the first signal, and the second signal are pulse-shaped signals with independent wavelengths and are radiated to be distributed into independent time bands.

7. The multi-wavelength sensing apparatus of claim 1, wherein the reference device includes a reference transmitter configured to radiate the reference device, and
wherein the reference transmitter is implemented with at least one of a radar, an ultrasonic device, a laser, and a LiDAR.

8. The multi-wavelength sensing apparatus of claim 7, wherein the first device includes a first transmitter configured to radiate the first signal,
wherein the second device includes a second transmitter configured to radiate the second signal, and
wherein each of the first transmitter and the second transmitter is implemented with at least one of a laser and an LED.

9. The multi-wavelength sensing apparatus of claim 8, wherein the first device further includes a first receiver configured to receive the first reflection signal,
wherein the second device further includes a second receiver configured to receive the second reflection signal, and
wherein each of the first receiver and the second receiver is implemented with at least one of a light detector array and an image sensor.

10. The multi-wavelength sensing apparatus of claim 9, wherein each of the reference device, the first device, and the second device further includes a filter configured to block a signal of any other wavelength band other than a radiation signal band.

11. The multi-wavelength sensing apparatus of claim 8, further comprising:
a receiver including a filter configured to block a signal of any other wavelength band other than a radiation signal band of each of the reference device, the first device, and the second device,
wherein the reference reflection signal, the first reflection signal, and the second reflection signal are received through the receiver.

12. The multi-wavelength sensing apparatus of claim 1, further comprising:
a third device configured to radiate a third signal with a third wavelength to the object, to receive a third reflection signal reflected from the object, and to process the third reflection signal to output third data including third two-dimensional information and a third amplitude value of the object,
wherein the first wavelength, the second wavelength, and the third wavelength are independent of each other, and
wherein the signal mapper maps the first data, the second data, and the third data based on the reference data and generates the mapping data.

13. The multi-wavelength sensing apparatus of claim 1, wherein the at least one processor includes at least one of a neural processing unit (NPU), a neuromorphic processor (NP), and a graphic processing unit (GPU).

14. An operation method of a multi-wavelength sensing apparatus, the method comprising:
radiating a reference signal, a first signal with a first wavelength, and a second signal with a second wavelength to an object located in a pre-defined region;
processing a reference reflection signal reflected from the object to generate reference data including reference three-dimensional information and a reference amplitude value of the object;
processing a first reflection signal reflected from the object to generate first data including first two-dimensional information and a first amplitude value of the object;
processing a second reflection signal reflected from the object to generate second data including second two-dimensional information and a second amplitude value of the object;
mapping the first data and the second data based on the reference data to output mapping data; and
post-processing the mapping data to obtain three-dimensional information of the object and characteristic information of the object.

15. The method of claim 14, wherein the first wavelength and the second wavelength are independent of each other, and
wherein at least one of the first signal and the second signal is a short wavelength infrared signal.
